(19) United States
(12) Patent Application Publication
(10) Pub. No.: US 2015/0159418 A1
(43) Pub. Date: Jun. 11, 2015

(54) PIECE OF FURNITURE AND DEVICE FOR MOVING A FURNITURE FLAP OF A PIECE OF FURNITURE

(71) Applicant: Grass GmbH, Höchst (AT)

(72) Inventors: Tobias ERDEL, Sindelfingen (DE); Rolf MINTGEN, Dornbirn (AT)

(21) Appl. No.: 14/565,757

(22) Filed: Dec. 10, 2014

Related U.S. Application Data
(63) Continuation of application No. PCT/EP2013/001578, filed on May 29, 2013.

(30) Foreign Application Priority Data
Jun. 11, 2012 (DE) 20 2012 005 606.9

(51) Int. Cl. E05F 15/603; E05F 15/632; E05F 1/08; E05F 15/605

(52) U.S. Cl. CPC E05F 15/603; E05F 15/605; E05F 15/632; E05F 1/08

(57) ABSTRACT

A device for moving a furniture flap of a piece of furniture is proposed, wherein the device has bearing means via which the furniture flap is movably accommodated on a furniture body. According to the invention, the device comprises a tension element arrangement, comprising a tension element and a drive motor for driving the tension element, in such a manner that, in the mounted state of the device, a first end of the tension element is received on a winding element and a second end of the tension element is assigned to the furniture flap, wherein the furniture flap is bringable out of a closed position relative to the furniture body into an open position by a winding-up operation of the tension element.

### CROSS REFERENCE TO RELATED APPLICATIONS

This application is a continuation of International Application No. PCT/EP2013/001578 filed May 29, 2013, which designated the United States, and claims the benefit under 35 USC §119(a)-(d) of German Application No. 20 2012 005 606.9 filed Jun. 11, 2012, the entireties of which are incorporated herein by reference.

### FIELD OF THE INVENTION

The invention relates to a piece of furniture and a device for moving a furniture flap of a piece of furniture.

### BACKGROUND OF THE INVENTION

Pieces of furniture comprising furniture flaps and devices for moving a furniture flap of a piece of furniture, wherein the device has bearing means via which the furniture flap is movably accommodated on a furniture body, are known.

When the furniture flap is positioned at an overhead height, a direct action of a user on the furniture flap is generally possible only to a limited extent, if at all. This necessitates particular requirements to be imposed on a corresponding movement device for moving the furniture flap.

### SUMMARY OF THE INVENTION

It is the object of the present invention to improve a piece of furniture and a device of the type mentioned at the beginning.

The invention is first of all based on a device for moving a furniture flap of a piece of furniture, wherein the device has bearing means via which the furniture flap is movably accommodated on a furniture body. The device is designed in particular as a furniture flap movement device and serves in particular for moving an upper flap or a pivoting or lifting flap.

The essential aspect of the device according to the invention resides in the fact that the device comprises a tension element arrangement, comprising a tension element and a drive motor for driving the tension element, in such a manner that, in the mounted state of the device, a first end of the tension element is received on a winding element and a second end of the tension element is assigned to the furniture flap, wherein the furniture flap is bringable out of a closed position relative to the furniture body into an open position by a winding-up operation of the tension element.

A device of this type is formable in a simple and space-saving manner. In addition, comparatively high tensile forces can be transmitted, in particular in an opening direction of the movable or pivotable furniture flap, by a thin and simple tension element.

Winding up also permits a defined or controlled and compact storage of the tension element such that the latter is later unwindable again in a defined manner.

With the winding-up of the tension element, the end which is assigned to the furniture flap and which is directly or indirectly fixed to the furniture flap is advantageously also changed in its position. Via the change in position, the furniture flap can be correspondingly adjusted in an infinitely variable manner in its flap position in the opening direction. With an ending or stopping of the winding-up movement of the tension element, the furniture flap can also be brought into virtually any intermediate positions between an entirely open and an entirely closed position with respect to the furniture body and can remain there.

The tension element is in particular of elongate and flexible or pliable design. Metal or plastic or a composite material is suitable as material for the tension element.

The tension element is loaded in tension by a counterforce during the opening movement of the furniture flap. The counterforce can be provided by different mechanisms.

Control of the movement of the furniture flap is realized, for example, by control of the drive motor. For this purpose, for example, there is a master control unit which comprises in particular a computer unit with an associated operating program or control software. Via drive motor operating data detectable and processable in the control unit and optionally further information, the winding-up or unwinding length of the tension element can be detected at any time and changed in a desired manner. On the basis of the abovementioned relationships regarding the winding-up and unwinding length of the tension element with the control unit and the drive motor controlled by the latter, each pivoting position of the furniture flap is therefore also precisely controllable, for example activatable.

By stopping the unwinding operation of the tension element before an unwinding length which corresponds to the entirely closed state of the furniture flap is reached, it is possible, for example, for the furniture flap to be stopped at any point and, for example, held there.

A further essential aspect of the invention resides in the fact that the device comprises a tension element arrangement, comprising a tension element and a drive motor for driving the tension element, in such a manner that, in the mounted state of the device, a first end of the tension element is received on a winding element and a second end of the tension element is assigned to the furniture flap, wherein the furniture flap is bringable out of a closed position relative to the furniture body into an open position by an unwinding operation of the tension element. The tension element is loaded in tension in the process. The tensile force acts in the closing direction of the furniture flap. The counterforce to the tensile force, which counterforce also acts counter to the weight exerted by the furniture flap, is provided, for example, by a separate arrangement. This is advantageously a mechanically acting spring arrangement which provides an opening force and acts on the furniture flap in such a manner that the latter is pushed in the opening direction. The spring arrangement provides a force on the furniture flap in the opening direction in particular over the entire possible movement path of the furniture flap between the completely closed and the completely open position of the furniture flap relative to the furniture body.

Advantageously, a simple, compact and space-saving arrangement is possible with the tension element. If use is made of a flexible tension element, the latter can advantageously take up a desired three-dimensional profile in a very variable manner, in particular from the winding element to the furniture flap. For this purpose, it is possible, for example, for a tension element guide to be provided, which tension element guide can comprise curved deflections and/or linear guide sections, along which the tension element is guided in particular in a sliding manner and/or is moved while being in engagement therewith, for example in the case of a rotating deflection pulley.

If the drive motor, for example, is not positioned on the furniture flap in a vertical direction above the engagement point of the tension element, deflections can be provided for deflecting the tension element. The deflections can optionally act in addition in the manner of a block and tackle arrangement in order to reduce the force to be applied for raising the weight caused by the furniture flap.

With the counterforce which is advantageously permanently in effect on the furniture flap, directly as a partial length of the wound-up tension element is let out, the spring force of the spring arrangement can become effective in a manner corresponding to a pivoting path, which is therefore possible, of the furniture flap, and the furniture flap is moved in the opening direction. The tension element here always remains loaded in tension. This permits a jolt-free movement of the furniture flap in the opening direction.

When the unwinding movement is stopped, in particular by the drive motor being switched off, the unwinding of the tension element is also stopped, and the furniture flap remains in the corresponding pivoting position and is held in the open position, wherein the tension element remains unmoved.

A further essential aspect of the invention resides in the fact that the device comprises a tension element arrangement, comprising a tension element and a drive motor for driving the tension element, in such a manner that, in the mounted state of the device, a first end of the tension element is received on a winding element and a second end of the tension element is assigned to the furniture flap such that, in the control mode, the furniture flap undergoes a driven movement by a winding-up operation or unwinding operation of the tension element, wherein freewheeling means are formed for a freewheeling function of the furniture flap, in order to move the furniture flap manually from the outside if the furniture flap does not undergo a driven movement by the tension element.

Therefore, even, for example, in the event of a function failure of the drive by means of the tension element or the drive motor, for example in the event of a power failure, the furniture flap can be opened and closed by hand or manually. The freewheeling function overcomes an optionally inhibiting action of the movement of the furniture flap by the bearing means and/or the tension element and the cooperation of the latter with the winding element and the drive motor.

The freewheeling function can be realized, for example, with the aid of a spring, for example in accordance with the restoring or rewinding principle.

The freewheeling function causes the tension element to be retracted, for example, when the furniture flap is opened and to be released again when the furniture flap is closed.

Owing to the spring of the freewheeling function, the closing of the furniture flap can take place more slowly than the opening. The furniture flap is braked or damped here during the closing operation.

A further function of the spring of the freewheeling function can be considered that of, when the furniture flap is at a standstill due to a malfunction of the spring, the drive motor being activated again and the furniture flap being brought into the open or closed position.

In addition, it is advantageous that the freewheeling means comprise a clutch. The clutch can be present in the drive train for driving the tension element, between the drive motor and a unit arranged downstream, wherein the clutch is actuable such that, in a released or decoupled state, the drive motor does not exert a driving effect on the furniture flap. In the decoupled state, the drive motor cannot oppose the movement of the furniture flap from the outside or manually or prevent the movement. The furniture flap can therefore be opened or closed manually independently of the drive train, which is positioned above the drive motor in the control mode, for the driving movement of the furniture flap.

It is also advantageous that the bearing means are coordinated in such a manner that a force is provided, by means of which the furniture flap is automatically movable relative to the furniture body in a closing direction or an opening direction, wherein the movement of the furniture flap take place depending on a winding operation of the tension element. The provided force can be set up, for example, on the basis of a technical force unit, for example comprising a chargeable force accumulator, such as a spring assembly or a spiral spring arrangement, or can be provided by the weight exerted by components which are present, such as, for example, the furniture flap itself. With the provided force, the furniture flap can be moved in a defined manner, wherein the effect of the provided force is determined via the tension element depending on the winding-up or unwinding operation of the tension element. The force can advantageously be realized in the closing direction of the furniture flap by the weight exerted by the furniture flap and in the opening direction by a technically chargeable and dischargeable force accumulator.

Furthermore, it is advantageous that the bearing means comprise a flap fitting comprising an adjustment lever and a spring arrangement, wherein the spring arrangement is designed to bring the furniture flap into an open position relative to the furniture body by a spring force which is providable by the spring arrangement. Known flap fittings can therefore be integrated in a device according to the invention or such flap fittings can optionally be retrospectively fitted in such a manner that the device according to the invention is realized.

An advantageous variant of the invention is distinguished in that the tension element is designed in such a manner that, in the mounted state of the device, the furniture flap is bringable into the closed position relative to the furniture body by a winding-up operation of the tension element onto the winding element. The in particular flexible tension element can therefore be brought into the closed position by a winding-up operation of the tension element onto the winding element. The drive motor serves here for the rotational drive of the winding element. With the drive motor or the control unit which controls the drive motor, the winding element can be rotated in a driven manner selectively or at any time in one of the two directions of rotation and, in a first direction of rotation, can wind up the tension element by shortening the free, non-wound-up part of the tension element or, in a second direction of rotation, can unwind the tension element by extending the free, non-wound-up part of the tension element. In the process, a counterforce acts on the furniture flap, the counterforce acting on the tension element in such a manner that the tension element is loaded in tension.

It is also of advantage that, in the mounted state of the device, the bearing means are configured in such a manner that the dynamic effect of the spring arrangement on the furniture flap is maintained during the opening operation. Undesired, non-defined and uncontrolled positions of the furniture flap can therefore be avoided. In particular, the effect which is achieved, for example, in the opening direction, by the permanently or uninterruptedly acting dynamic effect is that, for example, a, even if brief, pivoting of the furniture flap inward or in the closing direction is prevented. A jolt-free and uniform movement of the furniture flap that can therefore be realized is perceived to be agreeable by a user.

In an advantageous manner, in the mounted state of the device, the bearing means are configured in such a manner that, during a closing operation of the furniture flap, a force accumulator provided by the spring arrangement is charged. The spring arrangement provides in particular a dischargeable and rechargeable force accumulator which, for example, is charged in a manner coupled to a closing operation of the furniture flap such that the charged force accumulator of the spring arrangement is ready for a following force-driven opening operation.

The force accumulator of the spring arrangement that is at least partially discharged during an opening operation can thus be recharged by the next closing operation of the furniture flap. This increases the reliability of the function of the bearing means. In the closed state, the force accumulator is always automatically in a charged state.

It is also advantageous that the tension element is designed in such a manner that, in the mounted state of the device, a size of an opening width of the furniture flap is dependent of the length of the tension element unwound from the winding element. Depending on the unwound partial length of the tension element, a degree of opening or the opening width of the furniture flap is therefore predeterminable in a precise and finely graduated manner.

In an expedient variant of the invention, the bearing means are designed in such a manner that the driving force for a closing operation of the furniture flap from the open position into the closed position is substantially provided by the dead weight of the furniture flap. This permits a simple design of the device.

The closed furniture flap is moved here in the opening direction by the tension element, wherein the decisive counterforce is determined by the weight of the furniture flap.

In addition, it is advantageous in this variant embodiment that the driving force for moving the furniture flap from an entirely or partially open position in a closing direction is always available by the dead weight of the furniture flap, and, in particular, a drive for moving the furniture flap itself in the closing direction is not required. It is advantageous that the closing movement, the profile thereof and beginning and end are determinable via the tension element acting on the furniture flap. When the furniture flap is open and the previously wound-up tension element is subsequently unwound, the closed position or the closing movement is then predeterminable in accordance with the unwinding length of the tension element. The value of the unwinding length of the tension element is easily controllable.

According to a further advantageous variant of the invention, guide sections acting between the furniture flap and the furniture body are provided for a predetermined opening and closing movement of the furniture flap. A defined opening or closing movement of the furniture flap relative to the furniture body is preferably reliably ensured over the entire possible movement distance. The guide sections can comprise, for example, a linear guide which is present, for example, on an end side of the furniture body. For example, the furniture flap or a section of the furniture flap can slide along the guide sections on the end side of the furniture body. In this connection, it is advantageous that a virtually wear-free, e.g. plain bearing guide is formable for the furniture flap in relation to the furniture body.

In principle, the guide sections by themselves or in combination can comprise a slotted guide, a roller guide, a linear guide with, for example, two to three guide rails, or a lever mechanism.

The invention also relates to a piece of furniture comprising a furniture flap which is movably accommodated on a furniture body of the piece of furniture, wherein a device according to one of the abovementioned embodiments is provided. The corresponding advantages can therefore be realized on a piece of furniture comprising a furniture flap. The furniture flap is pivotable in particular about a substantially horizontal axis or is configured, for example, as an upper flap or as a vertically movable lifting flap.

It is advantageous here that the furniture flap comprises at least two flap elements which are divided in the vertical direction via a joint. This can be, for example, in the manner of a folding flap. The flap can thus correspondingly change its shape in a particularly flexible manner, with a desired opening width advantageously being providable.

### BRIEF DESCRIPTION OF THE DRAWINGS

Further features and advantages of the invention are depicted with reference to different exemplary embodiments of the invention that are illustrated in highly schematized form in the figures.

FIGS. 1 and 2 show a piece of furniture according to the invention illustrated in highly schematized form from the side without a side wall in two different positions of a furniture flap of the piece of furniture;

FIG. 3 shows a further piece of furniture according to the invention illustrated in highly schematized form in a side view with omission of a side wall and with a plurality of possible different attachment positions of a drive unit;

FIG. 4 shows the piece of furniture according to FIG. 1 in a side view without a tension element; and

FIGS. 5 and 6 show a further piece of furniture according to the invention in highly schematized form with omission of a side wall of the piece of furniture and in two different positions of a furniture flap of the piece of furniture.

### DETAILED DESCRIPTION OF THE INVENTION

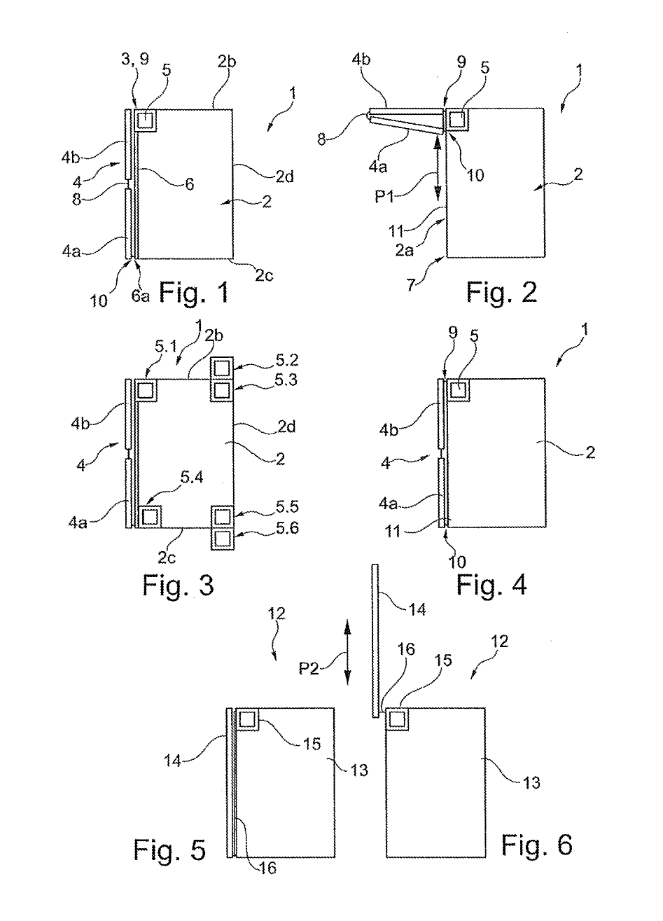

FIGS. 1 and 2 show a piece of furniture 1 comprising a furniture body 2 on which, for the temporary covering of a front side 2a, a furniture flap 4 is movably accommodated via a bearing point 3. FIG. 1 shows the completely closed furniture flap 4 and FIG. 2 shows the completely open furniture flap 4. In the installation state shown, the two-part furniture flap 4 is divided horizontally into a lower flap part 4a and an upper flap part 4b, which are connected in an articulated manner via a hinge 8.

The furniture body 2 has opposite side walls between an upper part 2b and a base 2c, and a rear wall 2d. The bearing point 3 forms a hinge 9, and therefore the upper flap part 4b is pivotable in relation to the furniture body 2 about a substantially horizontal axis close to or along a narrow end side of the upper part 2b. According to the invention, a flap fitting is not provided or necessary between the furniture body 2 and the furniture flap 4 in order to open the furniture flap 4 or to close same again. This is advantageous since such a flap fitting is generally comparatively complex.

The piece of furniture 1 serves, for example, as a top cupboard of a kitchen furniture arrangement, wherein the piece of furniture 1 can be positioned on a wall approximately at or above head height of an upright person. Such top cupboards are therefore frequently easily reachable only in the lower region thereof by a person.

Furthermore, there is a drive unit which is designed as an electric motor 5. According to FIGS. 1 and 2, the electric motor 5 is positioned on the upper part 2b or in the vicinity of the front side 2a in the upper region within the furniture body 2.

FIG. 3 shows further or alternative attachment positions with respect to the piece of furniture 1 for the electric motor 5. According thereto, the electric motor 5 is present in an attachment position 5.1 on the furniture flap 4 or the upper flap part 4b. The further attachment positions 5.2 and 5.6 are on an outer side of the upper part 2b and of the base 2c outside the interior of the furniture body 2. The attachment positions 5.3, 5.5 and 5.4 lie within the furniture body 2 in corner regions of the upper part 2b and the rear wall 2d, or of the rear wall 2d and the base 2c, or of the base 2d and the front side 2a.

A winding-up device (not illustrated) for winding up and unwinding a flexible tension element 6 is acted upon with the electric motor 5. The tension element 6 is connected at one end to a winding element of the winding-up device, which winding element is drivable rotatably by the electric motor 5, and is fixed at the other end 6a on the inside to a lower edge of the lower flap part 4a. The tension element 6 is guided freely or optionally merely in a sliding manner in-between, in particular tensioned with a slight tension. In addition, the lower flap part 4a is mounted in a sliding manner for a vertical movement according to double arrow P1 via two bearing points 10 which are present on the inside at the lower end of the flap part 4a and interact with a linear guide and with guide tracks 11 in the region of end sides 7 of the side walls of the furniture body 2. For this purpose, the guide tracks 11 are present, for example, continuously, in the region of the front-side end side 7 of the side walls of the furniture body, and the bearing points 10 slide along the guide tracks with little friction when the furniture flap 4 is moved upward or opened vertically, or moved downward or closed vertically relative to the furniture body 2.

FIG. 1 shows the state in which the tension element 6 is unwound and therefore the furniture flap 4, because of the dead weight, is in a closed state on the furniture body 2, or has moved into the closed state because of the dead weight and the tension element 6 which is unwound to an appropriately far extent.

FIG. 2 shows the furniture flap 4 in the completely open position relative to the furniture body 2. The two flap parts 4a and 4b are unfolded with respect to each other or are at an acute angle, wherein the two flap parts 4a, 4b open toward the front side 2a or move apart, as viewed from the hinge 8. In the completely open position of the furniture flap 4, the tension element 6 is wound up entirely or virtually entirely via the winding-up device, which takes place by a driven rotation of the winding element in the corresponding winding-up direction by means of the electric motor 5. After the winding-up operation, the electric motor is switched off. The tension element 6 is held here wound up in a fixed manner such that the tension element 6 holds the furniture flap 4 in the open position according to FIG. 2 under tension counter to the weight exerted by the furniture flap.

If the wound-up tension element 6 is unwound again via the electric motor 5, the lower flap part 4a slides by the bearing point 10 along the guide track 11 on the end sides 7 of the side walls.

FIG. 4 illustrates the piece of furniture 1 according to FIG. 1 without the tension element 6 for better illustration of the bearing point 10 and the guide track 11, wherein the bearing point 10 is guided in movement along the guide track 11.

FIGS. 5 and 6 show a further alternative arrangement of a piece of furniture 12 according to the invention with a furniture body 13 and a lifting flap 14. The lifting flap 14 is movable in the vertical direction according to the double arrow P2 via guide means (not illustrated specifically) by the drive unit 15 which is positioned in the front, upper region within the furniture body 13. Details of a cable pull arrangement with a tension element 16 which can be wound up and unwound by the drive unit 15 such that, in the wound-up state of the tension element 16, the arrangement according to FIG. 6, i.e. the open lifting flap 14, and, in the unwound state of the tension element 16, the closed lifting flap 14 according to FIG. 5 is achieved, are likewise not illustrated.

### LIST OF REFERENCE NUMBERS

1 Piece of furniture
2 Furniture body
2a Front side
2b Upper part
2c Base
2d Rear wall
3 Bearing point
4 Furniture flap
4a, 4b Flap part
5 Electric motor
6 Tension element
6a End
7 End side
8 Hinge
9 Hinge
10 Bearing point
11 Guide track
12 Piece of furniture
13 Furniture body
14 Lifting flap
15 Drive unit
16 Tension element

1. A device for moving a furniture flap of a piece of furniture, wherein the device has a bearing point via which the furniture flap is movably accommodated on a furniture body, wherein the device comprises a tension element arrangement, comprising a tension element and a drive motor for driving the tension element, in such a manner that, in the mounted state of the device, a first end of the tension element is received on a winding element and a second end of the tension element is assigned to the furniture flap, wherein the furniture flap is bringable out of a closed position relative to the furniture body into an open position by a winding-up operation of the tension element.

2. A device for moving a furniture flap of a piece of furniture, wherein the device has a bearing point via which the furniture flap is movably accommodated on a furniture body, wherein the device comprises a tension element arrangement, comprising a tension element and a drive motor for driving the tension element, in such a manner that, in the mounted state of the device, a first end of the tension element is received on a winding element and a second end of the tension element is assigned to the furniture flap, wherein the furniture flap is bringable out of a closed position relative to the furniture body into an open position by an unwinding operation of the tension element.

3. A device for moving a furniture flap of a piece of furniture, wherein the device has a bearing point via which the furniture flap is movably accommodated on a furniture body, wherein the device comprises a tension element arrangement, comprising a tension element and a drive motor for driving the tension element, in such a manner that, in the mounted state of the device, a first end of the tension element is received on a winding element and a second end of the tension element is assigned to the furniture flap such that, in the control mode, the furniture flap undergoes a driven movement by a winding-up operation or unwinding operation of the tension element, wherein a freewheeling part is formed for a freewheeling function of the furniture flap, in order to move the furniture flap manually from the outside if the furniture flap does not undergo a driven movement by the tension element.

4. The device as claimed in claim 3, wherein the freewheeling part comprises a clutch.

5. The device as claimed in claim 1, wherein the bearing point is coordinated in such a manner that a force is provided, by means of which the furniture flap is automatically movable relative to the furniture body in a closing direction or an opening direction, wherein the movement of the furniture flap takes place depending on a winding operation of the tension element.

6. The device as claimed in claim 1, wherein the bearing point comprises a flap fitting comprising an adjustment lever and a spring arrangement, wherein the spring arrangement is designed to bring the furniture flap into an open position relative to the furniture body by a spring force which is providable by the spring arrangement.

7. The device as claimed in claim 2, wherein the tension element is designed in such a manner that, in the mounted state of the device, the furniture flap is bringable into the closed position relative to the furniture body by a winding-up operation of the tension element onto the winding element.

8. The device as claimed in claim 2, wherein the mounted state of the device, the bearing point is configured in such a manner that the dynamic effect of the spring arrangement on the furniture flap is maintained during the opening operation.

9. The device as claimed in claim 2, wherein the mounted state of the device, the bearing point is configured in such a manner that, during a closing operation of the furniture flap, a force accumulator provided by the spring arrangement is charged.

10. The device as claimed in claim 2, wherein the tension element is designed in such a manner that, in the mounted state of the device, a size of an opening width of the furniture flap is dependent on the length of the tension element unwound from the winding element.

11. The device as claimed in claim 1, wherein the bearing point is designed in such a manner that the driving force for a closing operation of the furniture flap from the open position into the closed position is substantially provided by the dead weight of the furniture flap.

12. The device as claimed in claim 1, wherein the guide sections acting between the furniture flap and the furniture body are provided for a predetermined opening and closing movement of the furniture flap.

13. A piece of furniture comprising a furniture flap which is movably accommodated on a furniture body of the piece of furniture, wherein a device as claimed in claim 1 is provided.

14. The piece of furniture as claimed in claim 13, wherein the furniture flap comprises at least two flap elements which are divided in the vertical direction via a joint.

15. A piece of furniture comprising a furniture flap which is movably accommodated on a furniture body of the piece of furniture, wherein a device as claimed in claim 2 is provided.

16. The piece of furniture as claimed in claim 15, wherein the furniture flap comprises at least two flap elements which are divided in the vertical direction via a joint.

17. A piece of furniture comprising a furniture flap which is movably accommodated on a furniture body of the piece of furniture, wherein a device as claimed in claim 3 is provided.

18. The piece of furniture as claimed in claim 17, wherein the furniture flap comprises at least two flap elements which are divided in the vertical direction via a joint.

19. The device as claimed in claim 2, wherein the bearing point is coordinated in such a manner that a force is provided, by means of which the furniture flap is automatically movable relative to the furniture body in a closing direction or an opening direction, wherein the movement of the furniture flap takes place depending on a winding operation of the tension element.

20. The device as claimed in claim 3, wherein the bearing point is coordinated in such a manner that a force is provided, by means of which the furniture flap is automatically movable relative to the furniture body in a closing direction or an opening direction, wherein the movement of the furniture flap takes place depending on a winding operation of the tension element.

21. The device as claimed in claim 2, wherein the bearing point comprises a flap fitting comprising an adjustment lever and a spring arrangement, wherein the spring arrangement is designed to bring the furniture flap into an open position relative to the furniture body by a spring force which is providable by the spring arrangement.

22. The device as claimed in claim 3, wherein the bearing point comprises a flap fitting comprising an adjustment lever and a spring arrangement, wherein the spring arrangement is designed to bring the furniture flap into an open position relative to the furniture body by a spring force which is providable by the spring arrangement.

23. The device as claimed in claim 2, wherein the bearing point is designed in such a manner that the driving force for a closing operation of the furniture flap from the open position into the closed position is substantially provided by the dead weight of the furniture flap.

24. The device as claimed in claim 3, wherein the bearing point is designed in such a manner that the driving force for a closing operation of the furniture flap from the open position into the closed position is substantially provided by the dead weight of the furniture flap.

25. The device as claimed in claim 3, wherein the tension element is designed in such a manner that, in the mounted state of the device, the furniture flap is bringable into the closed position relative to the furniture body by a winding-up operation of the tension element onto the winding element.

26. The device as claimed in claim 3, wherein the mounted state of the device, the bearing point is configured in such a manner that the dynamic effect of the spring arrangement on the furniture flap is maintained during the opening operation.

27. The device as claimed in claim 3, wherein the mounted state of the device, the bearing point is configured in such a manner that, during a closing operation of the furniture flap, a force accumulator provided by the spring arrangement is charged.

28. The device as claimed in claim 3, wherein the tension element is designed in such a manner that, in the mounted state of the device, a size of an opening width of the furniture flap is dependent on the length of the tension element unwound from the winding element.
